(19) United States
(12) Patent Application Publication
(10) Pub. No.: US 2004/0111671 A1
(43) Pub. Date: Jun. 10, 2004

(54) Method for selectively reloading frames of a web-page

(75) Inventors: Yen Lu, Toronto (CA); Jeffrey Y. Liu, Toronto (CA)

Correspondence Address: Marilyn S. Dawkins, International Business Machines,, Intellectual Property Law, 11400 Burnet Road, Austin, TX, 78758, US

(73) Assignee: INTERNATIONAL BUSINESS MACHINES CORPORATION, ARMONK, NY

(21) Appl. No.: 10/668,399

(22) Filed: Sep. 23, 2003

(30) Foreign Application Priority Data
Dec. 6, 2002 (CA) 2413684

(51) Int. Cl. G06F 17/00

(52) U.S. Cl. 715/513

(57) ABSTRACT

A web page architecture permits the selective reloading of frames so that only selected frames are reloaded, regardless of their membership in one or more framesets. A target frame in the web page is used as a work area, and a script associated the work area is executed to reload the selected frames.

### CROSS-REFERENCE TO RELATED APPLICATIONS

This is the first application filed for the present invention.

### MICROFICHE APPENDIX

Not Applicable.

### TECHNICAL FIELD

The invention relates to the field of worldwide web page design and, in particular, to a worldwide web page design that permits the reloading of only a set of selected frames in a worldwide web page, regardless of a membership of the selected frames in any one or more framesets of the web page.

### BACKGROUND OF THE INVENTION

The Internet is a popular medium that is well supported by a host of technologies and governed by a progressive consortium that continually enhances its quality and operation. However the enhancements do not meet the growing demand for innovation in the communications that the Internet provides. As is well known, the worldwide web plays an increasingly important role in the Internet. The principal communications medium of the worldwide web is the worldwide web page (hereinafter referred to simply as “web pages”. The constitution of web pages has been changing continuously from the original bare text rendered using hypertext marking language (HTML), with the incorporation of images; audio, and other streaming data; and applets and programs that can provide services in the form of data and executable programs. The formats of HTML pages have changed too. Current web browser applications support frames and forms that facilitate an exchange of data between web servers and web clients and permit the subdivision of web pages into numerous panes that can independently receive dynamic and static source display data. Consequent to these advances, more data is exchanged over the Internet, and consequent to the growth in the number of Internet users, many users are experiencing increased delays when downloading web pages.

Dynamic web pages change in response to user input, environment variables, updates to databases, etc. In the course of interacting with a dynamic web page, the user may supply input, or actions taken by a user may trigger client-side scripts that cause information to be sent to the server. This server input may trigger a change in the dynamic web page. In many cases, it is desirable to dynamically update the web page in response to a trigger event. The mechanism for doing this usually requires refreshing, or reloading a frame or a frameset associated with the pane, in a manner well known in the art.

Because of the nature of hyper-text markup language (HTML), a trigger event can only be associated with one target frame or target frameset. That is to say, if a user selects an interactive icon (or enters a value in a field, etc.) the effect of the input can cause a reload of the entire dynamic web page or a selected portion of it (one frame or one frameset). Unfortunately, multiple concurrent targets are not supported.

In the prior art, this limitation has been overcome by creating a frameset containing all of the frames that are to be reloaded. This is possible because, according to the frame structure of web pages, each frame is a member of a frameset, which may also be a member of other framesets, etc. Thus, in a recursive manner, the web page can be divided into smaller and smaller framesets, etc. The reloading of a frameset involves reloading and presenting each pane in each frame that is a member of the frameset. As is well understood in the art of web page design, it is rarely desirable or aesthetic to arrange all of the frames of a web page for efficient reloading of only some of the frames in response to trigger events. Consequently, desirable effects are either sacrificed, or a great number of frames that do not require update are reloaded when a portion of a page requires refresh. This increases Internet traffic, and may appreciably slow down response time. Web servers are also unduly taxed by the need to re-render large parts of web pages that are already correctly rendered.

It is known in the art that dynamic framesets can be created using JavaScript to write the frameset to a document, thereby overriding already present HTML. A method for doing this is taught, for example, in “Mortens' JavaScript Tree Menu—InstallGuide—The Frameset” (available on the worldwide web at treemenu.com). This enables menus for JavaScript-enabled browsers to create framesets on-the-fly, instead of using static HTML framesets displayed by browsers that are not JavaScript enabled. The framesets created on-the-fly are enabled using scripts stored in a frame with a size of zero, which means that the frame is invisible in most browsers. While framesets created on-the-fly improve flexibility and improve efficiency for simple dynamic pages, they still do not provide the flexibility or the level of efficiency required to support more complex dynamic pages where frame control at a sub-frameset level is desirable for the sake of improved functionality and network traffic control.

There therefore exists a need for a method of creating a dynamic web page that can be adapted to reload only selected frames of the dynamic web page in response to a trigger event, regardless of a membership of the frames in any given frameset.

### SUMMARY OF THE INVENTION

Accordingly an object of the invention is to provide a method of creating a web page that can reload any number of selected frames of the web page, regardless of a membership of the selected frames in framesets used to create the web page.

Accordingly, the invention provides a method for creating a web page adapted to automatically reload selected frames of the web page in response to a trigger event. The method comprises defining a target frame for the web page to serve as a work area, associating an action with the trigger event, the action having the target frame as a target, and associating programmed logic with the action, the programmed logic being adapted to reload only the selected frames, regardless of a membership of the selected frames in framesets used to create the web page.

Defining the target may involve including a named frame that is a member of a frameset having a static source. The named frame is a frame of null dimension, it can be a static frame or a dynamic frame. If the named frame is a frame of null dimension, it be a frame that is defined as a row of 0 depth at a top or a bottom of the web page; or as a frame that is defined as a column of 0 width at either side of the web page, for example. Consequently, the including of the named frame may involve using a first frameset tag in the web page to partition the web page into a main frameset comprising a plurality of frames, and the target named frame.

The step of providing the action may involve providing logic for independently reloading a set of frames of the web page in dependence on a predefined set of conditions. The logic may be programmed as one or more scriptlets embedded in an HTML document. Server-side functions may also be used to control what frames are reloaded.

Also provided in accordance with the invention, is a web page having a plurality of frames. The web page comprises a target frame, and a script associated with the target frame and adapted to reload only selected frames of any frameset used to create the web page.

The target frame may be a frame in a frameset having a static source. It may be a dynamic frame, or a frame that is not displayed to a user and has at least one null dimension.

The trigger may be any event that causes activation of the script, e.g. an environment variable, a time-out timer expiring, a setting of a web browser that presents the web page, or an input to the computer. In particular the trigger may be a link or a form that has the script as an action attribute and the target frame as a target attribute. Alternatively, the action attribute may be a dynamic uniform resource locator (url) of a dynamic web page that includes the script. Once the url is downloaded to the target frame, the script is returned with rendering information, and provides a set of instructions that include instructions for reloading selected web pages to respective frames.

The invention also provides an article that includes a computer readable modulated carrier signal, and means embedded in the signal for communicating to a client computer a web page as previously defined.

In accordance with a further aspect of the invention, an article is provided that includes a computer readable memory for storing a web page as previously defined.

In accordance with yet another aspect of the invention, an article is provided. The article includes a computer readable modulated carrier signal, and means embedded in the signal for communicating to a client computer, a message. The message contains rendering information in response to a request for a dynamic web page, and client side code for reloading two or more frames in a web page, wherein any selected frame is reloaded regardless of a membership of the selected frames in any number of framesets used to define the page.

In accordance with another aspect, the invention provides readable medium for storing program instructions for reloading only selected frames in at least two framesets of a web page, the computer readable medium comprising instructions for instantiating a target frame; and instructions for reloading only the selected frames, the instructions for reloading being initiated by an activation of a trigger associated with the target frame.

The instructions for instantiating preferably include a file written in hypertext markup language (HTML), that includes a plurality of frameset definitions, including a definition of the target frame. The file may further include an event handling mechanism that associates the trigger with an action that comprises the instructions for reloading.

### BRIEF DESCRIPTION OF THE DRAWINGS

Further features and advantages of the present invention will become apparent from the following detailed description, taken in combination with the appended drawings, in which:

FIG. 1 is a schematic diagram illustrating a networked environment in which the invention may be deployed;

FIG. 2 is a flow chart illustrating principal steps involved in constructing a web page adapted to selectively reload frames in accordance with the invention;

FIG. 3 is a schematic diagram illustrating steps in a process of selectively reloading frames, overlaid on a schematic diagram illustrating an example of a web page;

FIG. 4 is a message flow diagram illustrating principal messages used in a process of reloading selected frames, in accordance with an embodiment of the invention; and

FIG. 5 is a flow chart illustrating principal steps in a method in accordance with the invention for selectively reloading frames of a web page.

It should be noted that throughout the appended drawings, like features are identified by like reference numerals.

### DETAILED DESCRIPTION OF THE PREFERRED EMBODIMENT

The invention enables the creation of a dynamic web page that can reload only selected frames in response to a trigger event, regardless of a membership of any of the selected frames in one or more framesets. The invention utilizes scripts associated with an action initiated by a trigger event to effect a plurality of reload requests to reload the respective frames.

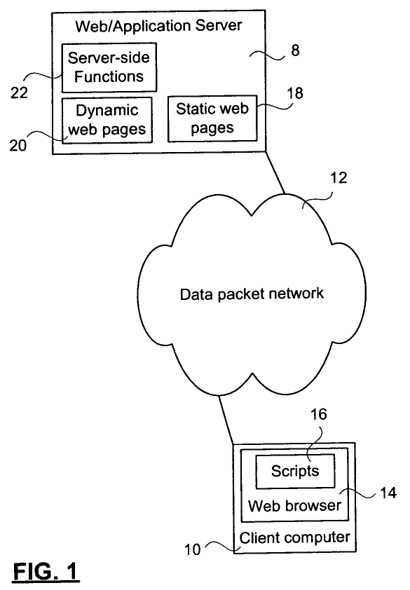

FIG. 1 schematically illustrates a networked environment in which the present invention may be deployed. A web server 8 and a client computer 10, are communicatively interconnected by a data packet network 12, such as the Internet, and intranet or the like in a manner well known in the art. The client computer 10 may be connected to the network 12 in any number of ways using a dial-up connection, cable or digital subscriber line, etc. The web server 8 is normally connected directly to the Internet (not shown), which supports the worldwide web, but could be a part of, or include, a back-end system that is accessed using other communications protocols.

The client computer 10 accesses the data packet network 12 using any of a number of available web browsers 14. Most current web browsers 14 support scripts 16, which provide client-side program code for effecting a presentation of web pages, and enabling communications with the web server 8 to enhance interactivity between the web server 8 and a user of the client computer 10, in a manner known in the art. The web server 8 is adapted to serve static (HTML) web pages 18, and dynamic web pages 20. Dynamic pages are enabled by technologies such as “java server pages”, and “active server pages” both of which are well known in the art. The rendering of a dynamic web page, involves adapting a content of the dynamic web page prior to rendering or re-rendering, and may depend on any number of environment variables related to the server, any state of a program being executed, and user input which, of course, includes data that the scripts 16 of the web page are programmed to collect, inspect and/or transmit to the web server. Server-side programs 22, may be java servlets, server-side includes (SSI), common gateway interface (CGI) scripts, or any other program model used to render dynamic web pages.

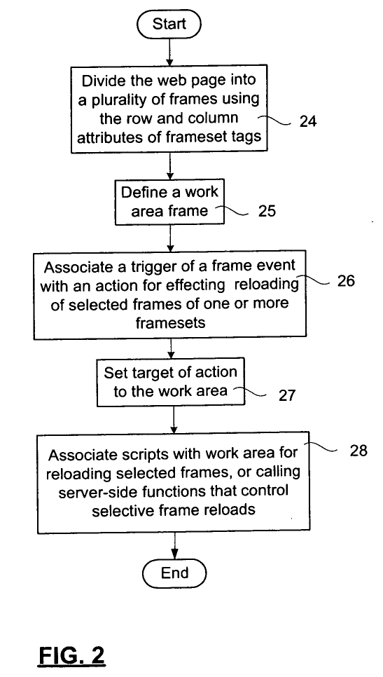

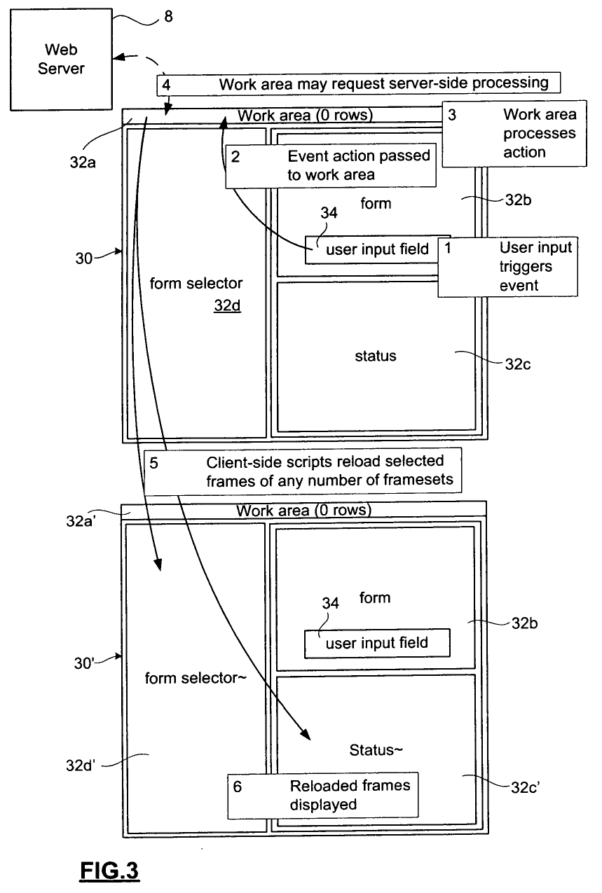

FIG. 2 is a flow diagram that outlines the principal steps involved in creating a dynamic web page in accordance with the invention. In step 24, the web page is divided into a plurality of frames using the row and column attributes of frameset tags in the normal way. The frames can be defined as members of one or more framesets. A “work area” frame is likewise defined (step 25). As explained below in more detail, the work area frame may be a null frame (0 rows), or any other frame of the page. After the work area frame is defined, a frame event trigger, which is normally triggered by some form of user input, is associated with a script action for effecting a reload of selected frames of one or more framesets of the dynamic web page (step 26). A target of the action is set to equal the work area page (step 27). Thereafter, scripts are associated with the work area (step 28). The scripts may instantiate logic for reloading the selected frames, or may call server side functions that control selection frame reloads, as will be explained in more detail below. FIG. 3 schematically illustrates a simple example of a dynamic web page 30 in accordance with the invention. The web page 30 is divided into 4 frames 32. The frames 32 are members of a first frameset that separates the work area frame 32a from a main frameset. As schematically illustrated, the work area frame 32a is defined as having a height of 0 (zero) rows. And so the first frameset could be defined, for example using the following html code:

<!--Web page's GUI: all.jsp -->
<html>
<frameset rows=“0,*”>

<frame name=“work area”>
<frame name=“main frameset”src=“main.jsp”>

</frameset>
</html>

where the main frameset is associated with substantially the entire displayed web page. Depending on the web browser used to display the web page, the work area frame 32a may actually have a very narrow visible part. The work area frame 32a may equally have been specified to be the bottom row, by reversing the values in the rows expression (“*,0”), and reversing the order in which the frames are specified. Further, there is no advantage to using a rows expression over a columns (cols) expression. Thus the work area frame 32 could equally have been any of the top, bottom, right side or left side of the main frameset. As will be immediately evident to those skilled in the art, this is by no means the extent of the ways in which frames of null dimension can be embedded in a web page. It will be understood that any frameset declaration can contain a hidden frame at the beginning, end or in between other frames.

For the operation of the present invention, a target frame needs to be defined, but the target frame, which is referred to as a “work area”, is not necessarily defined as frame of null dimension. The target frame simply provides a mechanism for initiating the execution of program code, normally a script. While any frame can be used for the target, a null frame is a good option because it is never shown to the user.

The main frameset in this example is divided into two columns, one containing a frameset of two frames 32b,c called form and status, respectively, the other column being a frame 32d called form selector. It will be presumed that in most embodiments each of these frames will provide panes that display text, images, streaming media, and user input fields for text input, radio buttons, dynamic links or hypertext links, etc. All of the roll-over and dynamic visual effects that today's browsers and servers can produce may be presented in one or more of these frames. Of these many effects, only one schematically illustrated user input field 34 is provided for the sake of simplicity of the illustration. This may be a button, a text box, or any other mechanism known in the art that supports user input.

The user input field 34 may be defined as follows, in accordance with the present invention:

<!--forms.jsp -->
<html>
<body>

<form action=“processform.jsp”target=work area>
...code for defining user input field...
</form>

</body>
</html>

The attribute of the form called action provides that when the form is submitted, the processform.jsp, which is a url, is passed to the work area. The resulting content in the work area will selectively reload frames of the dynamic web page, regardless of a frameset(s) of which the selected frames are members. The action attribute runs a server side function 22, which may serve up any frame in any frameset of the web page depending on a value of any number of predefined variables.

One embodiment of an action attribute script includes the following schematic code:

<!--processform.jsp -->
<html>
<body>
<% ...code for server side functions...,condition
{%>
<script language=“javascript”>
top.frames[“main frameset”].frames[“form selector”]. location=“form

selector2.jsp”;

top.frames[“main frameset”].frames[“form rightside”].

frames[“status”].location=“status2.jsp”;

</script>
<% } %>
</body>
</html>

The scriptlets delimited by “<%,%>” are executed on the server. The code for server side functions is used to apply a predefined set of operations that re-renders the selected frames for the client. The client computer 10 then receives an HTML plus Javascript document that is the processform.jsp, after it has been processed by the server 8 (e.g., the code for server side functions 22 may add additional HTML/Javascript code, or it may remove sections of processform.jsp), The instructions outside of the “<% . . . %> instruct the web browser 14 to reload the re-rendered status frame 32c and form selector frame 32d. Advantageously, the reloading of the form frame 32b, a part of the main frameset is avoided. Thus, response time is improved and network traffic is reduced.

Overlying the illustrated web page are steps in the process of selectively reloading selected frames of the web page. By the term “selectively reloading”, means reloading only selected frames from any number of framesets of the web page, regardless of the framesets of which the selected frames are members. In other words, the respective selected frames can be members of any frameset defined on the page, and the frames can be selected from any number of framesets defined for the page.

In a first step, a viewer inputs data into the user input field 34, triggering an event. As noted above, the event could be triggered in other ways. The event action is passed to the work area, in the second step. The script associated with the event action is executed, or the dynamic page is downloaded to the work area in step three. If the action attributes invokes a server-side function 22(FIG. 1), the code executed by the server-side function 22 is sent to the web server 8, and a response, including a script and selected frame rendering information, is returned in step four. In either case, a script is now interpreted or executed and runs in the work area. The script includes instructions for identifying a sequence of frames that need to be reloaded, which is performed in step five. In the sixth and final step, the selected frames, frames 32c,d are presented to the viewer. As will be appreciated by those skilled in the art, the re-rendered frames may be as different from the previously rendered frames as the programmed rendering accommodates.

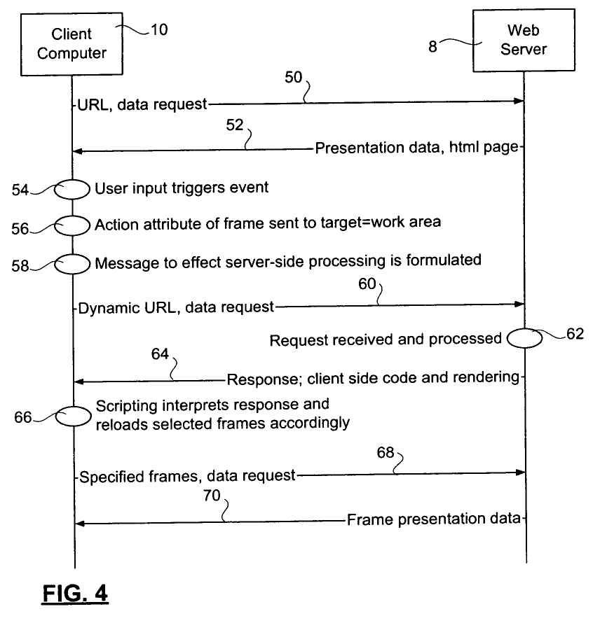

FIG. 4 illustrates principal messages exchanged during a selective reloading of frames in a web page, in accordance with an embodiment of the invention. In step 50, the web page is requested using standard IP messaging. In step 52 the presentation information corresponding to the web page is forwarded to the client computer 10. A computer readable modulated carrier signal is used to communicate the web page, in a manner well known in the art. The web page is presented to a user, and the user triggers an event. This may be performed, for example, by submitting a form, or by selecting a button or other user-selectable icon.

In step 56, an action associated with the event is passed to the work area, which is the target of the action. The action attribute executes a script used to collect data required for server-side processing, and to formulate a request for a server-side function (step 58). The request is sent (step 60) to a specified url. The web server 8 receives the request message, and analyzes the request (step 62). More specifically, the web server 8 receives the collected data included in the message, and the server-side code. The web server 8 forwards the request to an application server, which may be instantiated on the same or a different machine, and the application server interprets the server-side code, and executes the servlet. As is known in the art, the processing may be responsive to any number of variables including the data forwarded with the request.

The client-side code included in the request message may be supplemented or modified in a manner known in the art, and, in step 64, a response is returned with the client side code. A computer readable modulated carrier signal is used to communicate the rendering information and client-side code to enable reloading frames of the web page. The client-side code is processed (step 66). At least a part of the client-side code includes instructions for the reloading of the selected frames, in accordance with the present invention. Each of the selected frames is reloaded, using server requests in steps 68, and 70.

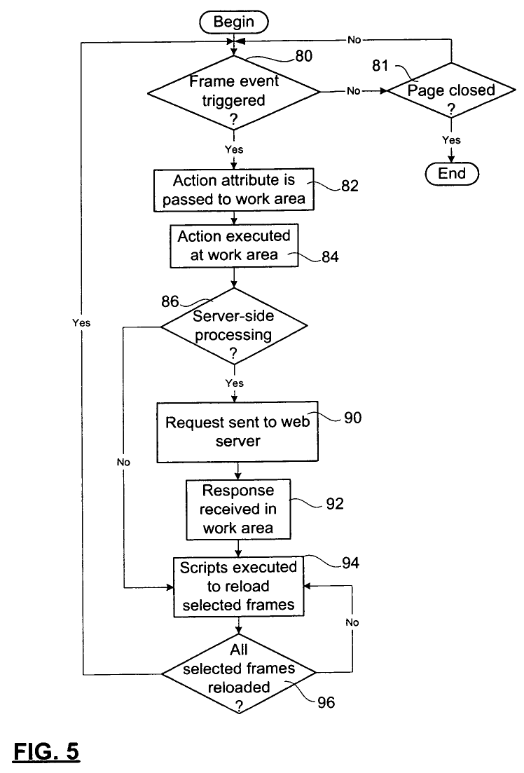

FIG. 5 is a flow chart illustrating principal steps involved in effecting the selective reloading of frames of a web page in accordance with the invention. In step 80, the web page is monitored to determine when a frame event occurs, or the page is closed (step 81). If the page is closed, processing ends when an event is triggered, the event has an associated action that is passed to the target frame (work area) in step 82. The work area executes a script associated with the action (step 84). If the script initiates server-side processing a request is formulated and sent (step 90) to the web server 8, as described above with reference to FIG. 4. After the web/application server has processed the request, it returns a response to the work area (step 92), alternatively, the script executed by the work area may include logic required to directly reload the selected frames. In either case, scripts, are executed to reload the selected frames, in step 94. Once all of the selected frames have been reloaded as determined in step 96 the browser waits for another frame event to be triggered (detected in step 80), or for the closing of the web page (step 81).

The embodiments of the invention described above are intended to be exemplary only. The scope of the invention is therefore intended to be limited solely by the scope of the appended claims.

We claim:

1. A method for creating a web page adapted to automatically reload selected frames of the web page in response to a trigger event, the method comprising:
defining a target frame for the web page to serve as a work area;
associating an action with the trigger event, the action having the target frame as a target; and
associating programmed logic with the action, the programmed logic being adapted to reload only the selected frames, regardless of a membership of the selected frames in framesets used to create the web page.

2. A method as claimed in claim 1 wherein defining the target frame comprises defining a named frame with a static source in a frameset of the web page.

3. A method as claimed in claim 2 wherein defining the named frame comprises defining the target frame as a frame having a null dimension.

4. A method as claimed in claim 3 wherein defining the named frame comprises defining a frame of 0 rows and 0 columns at an edge of the web page.

5. A method as claimed in claim 3 wherein defining the frame further comprises using a first frameset tag in the web page to partition the web page into a main frameset comprising a plurality of frames, and the target frame having the null dimension.

6. A method as claimed in claim 1 further comprising associating the action with programmed logic for reloading only the selected frames of the web page in dependence on a predefined set of conditions.

7. A method as claimed in claim 1 further comprising accessing server-side functions in dependence on a predefined set of conditions.

8. A method as claimed in claim 7 further comprising providing a link to a dynamic uniform resource locator.

9. A method as claimed in claim 8 wherein providing the link comprises providing a dynamic server page link.

10. A web page having a plurality of frames, comprising:
a target frame; and
a script associated with the target frame and adapted to reload only selected frames of any frameset used to create the web page.

11. A web page as claimed in claim 10 wherein the target frame is a member of a frameset having a static source.

12. A web page as claimed in claim 10 wherein the target frame is a frame with null dimensions.

13. A web page as claimed in claim 12 wherein the target frame is defined by a frameset tag that provides a main frameset and the target frame has 0 columns and 0 rows.

14. A web page as claimed in claim 13 wherein the trigger comprises one of a link and a form that has the script as an action attribute and the target frame as a target attribute.

15. A web page as claimed in claim 14 wherein the action attribute comprises a uniform resource locator (url) of a dynamic web page that includes the script and effects the downloading of the dynamic web page to the target frame, and the returned script with rendering information provides a set of instructions that include instructions for reloading only the respective selected frames, regardless of respective membership of the selected frames in framesets of the web page.

16. An article comprising:
a computer readable modulated carrier signal; and
means embedded in the signal for communicating to a client computer a web page as claimed in any of claims 10 to 15.

17. An article comprising a computer readable memory for storing a web page as claimed in any of claims 10 to 15.

18. An article comprising:
a computer readable modulated carrier signal; and
means embedded in the signal for communicating to a client computer, a message containing:
rendering information in response to a request for a server-side processing; and
client side code for reloading only selected frames of a web page, regardless of a frameset which the respective frames are members.

19. An article as claimed in claim 18 wherein the computer rendering information is targeted to a work area frame of null dimension.

20. A computer readable medium for storing program instructions for reloading only selected frames in at least two framesets of a web page, the computer readable medium comprising:
instructions for instantiating a target frame; and
instructions for reloading only the selected frames, the instructions for reloading being initiated by an activation of a trigger associated with the target frame.

21. A computer readable medium as claimed in claim 20 wherein the instructions for instantiating comprise a file written in hypertext markup language (HTML), that comprises a plurality of frameset definitions, including a definition of the target frame.

22. A computer readable medium as claimed in claim 21 wherein the file further comprises an event handling mechanism that associates the trigger with an action that comprises the instructions for reloading.

23. A computer readable medium as claimed in claim 22 wherein the action is an attribute of one of a link and a form, and the event is a corresponding one of a selection of the link, and a submission of the form.

24. A computer readable medium as claimed in claim 23 wherein the one of the link and the form has a target attribute set to the target frame.

25. A computer readable medium as claimed in claim 24 wherein the target frame is a member of a frameset that has a static source.

26. A computer readable medium as claimed in claim 25 wherein the target frame has null dimensions.
